(19) United States
(12) Patent Application Publication
(10) Pub. No.: US 2005/0106348 A1
(43) Pub. Date: May 19, 2005

(54) Wire-protective tube

(75) Inventors: Masato Koike, Susono-shi (JP); Atsushi Sugiyama, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/705,834

(22) Filed: Nov. 13, 2003

(51) Int. Cl. B32B 1/08

(52) U.S. Cl. 428/36.9

(57) ABSTRACT

A wire-protective tube comprising a resin composition comprising (A) a mixture comprising a microblend and a modified miocroblend, (B) from 0 to 700 parts by weight of a polypropylene based on 100 parts by weight of the mixture, and (C) from 5 to 200 parts by weight of an ionically crosslinking filler based on 100 parts by weight of the sum of ingredients (A) and (B), wherein the resin composition has a flexural modulus of 2,000 MPa or lower.

### FIELD OF THE INVENTION

The present invention relates to a novel wire-protective tube comprising a polypropylene resin. More particularly, the invention relates to a wire-protective tube which not only can exhibit excellent properties equal or, in some cases, superior to those of the wire-protective tubes comprising a flexible vinyl chloride resin (hereinafter often referred to as “PVC”) but also has excellent productivity by extrusion molding.

### BACKGROUND ART

Widely known wire-protective tubes for use in the protection/binding of electric wires are ones comprising PVC as the main material. Wire-protective tubes of this kind are excellent in abrasion resistance, flexing properties for wire binding, etc. due to the properties of the flexible vinyl chloride resin. In addition, these tubes have satisfactory water and oil resistance and have been frequently used for the protection/binding of domestic and automotive wires.

The wire-protective tubes comprising PVC, however, impose a considerable burden on the environment and, from this standpoint, wire-protective tubes containing no PVC are being developed. In particular, various wire-protective tubes comprising a polyolefin resin excellent in water resistance and oil resistance have been proposed. At present, the wire-protective tubes mainly used among such tubes are ones comprising as the main material a flexible polyolefin consisting mainly of an elastomer containing a large proportion of ethylene unit for exhibiting-flexibility.

However, the flexible polyolefin has a problem that since it contains ethylene unit in a large proportion, the wire-protective tubes obtained therefrom have poor heat resistance. In addition, because of the insufficient rubbery properties of the resin, the wire-protective tubes comprising the flexible polyolefin have problems, for example, that winding is difficult during tube production and the tubes show poor flexing properties in wire binding, resulting in poor workability in binding. An inorganic filler is generally incorporated into the flexible polyolefin for the purpose of improving the mechanical strength of the wire-protective tube to be obtained or imparting flame retardancy thereto. However, this incorporation of an inorganic filler has a problem that the wire-protective tube obtained from the polyolefin has reduced abrasion resistance. Especially when the flexural modulus of the flexible polyolefin is regulated to 2,000 MPa or lower so as to impart flexibility, the wire-protective tube obtained from this polyolefin has considerably reduced scrape resistance.

It has hence been proposed to use a modified flexible polyolefin resin obtained by modifying a flexible polyolefin by bonding organic acid groups thereto, for the purpose of improving the abrasion resistance of the wire-protective tubes comprising a flexible polyolefin containing an inorganic filler. However, this technique not only is insufficient in the effect of improving scrape resistance but also has attained-no improvement in heat resistance so far.

### SUMMARY OF THE INVENTION

Accordingly, an object of the invention is to provide a wire-protective tube which not only has the satisfactory insulating properties, water resistance, and oil resistance possessed by flexible polyolefins, but also is improved in flexing property, scrape resistance, and heat resistance and has satisfactory productivity.

The present inventors made intensive investigations in order to overcome the problems described above. As a result, they have found that all those problems can be eliminated by using as a wire-protective tube material a composition obtained by incorporating an ionically crosslinking filler into a mixture of: a microblend which comprises a polypropylene and a propylene/ethylene random copolymer, is made up of units including propylene unit as the main component, and has a specific crystallinity distribution as determined by the temperature-rising elution fractionation method; and a modified microblend obtained by modifying part of the microblend with an acid. The invention has been completed based on this finding.

That is, the present invention provides a wire-protective tube as follows in order to accomplish the aforementioned object.

(1) A wire-protective tube comprising a resin composition comprising:
(A) a mixture comprising a microblend and a modified miocroblend,
wherein the microblend comprises from 1 to 70% by weight of polypropylene and from 99 to 30% by weight of propylene/ethylene random copolymer comprising from 15 to 50% by mole of ethylene unit and from 85 to 50% by mole of propylene unit,
wherein (a) a component eluted in the temperature range of from −40° C. to less than 20° C. is included in an amount of from 20 to 80% by weight, (b) a component eluted in the temperature range of from 20° C. to less than 100° C. is included in an amount of from 10 to 70% by weight, and (c) a component eluted at 100° C. or higher is included in an amount of from 1 to 40% by weight according to the temperature-rising elution fractionation method using o-dichlorobenzene as a solvent,
wherein the content of a component eluted in the temperature range of from −40° C. to 30° C. is from 10 to 90% by weight based on all the components according to the temperature-rising elution fractionation method using o-dibromobenzene as a solvent, and
wherein the modified microblend comprises the microblend and organic acid groups bonded thereto, wherein the amount of the organic acid groups is from 0.01 to 1 mmol based on 1 g of the sum of the microblend and the modified microblend,
(B) from 0 to 700 parts by weight of a polypropylene based on 100 parts by weight of the mixture, and
(C) from 5 to 200 parts by weight of an ionically crosslinking filler based on 100 parts by weight of the sum of ingredients (A) and (B),
wherein the resin composition has a flexural modulus of 2,000 MPa or lower.

(2) The wire-protective tube according to the above (1), wherein the mixture comprises the microblend in an amount of from 10 to 90% by weight and the modified microblend in an amount of from 90 to 10% by weight.

(3) The wire-protective tube according to the above (1), wherein the resin composition contains a gel in an amount of from 10 to 80% by weight.

(4) The wire-protective tube according to the above (1), wherein the ionically crosslinking filler is magnesium hydroxide.

In the present invention, the values of flexural modulus were obtained through measurements in accordance with JIS K7203. The temperature-rising elution fractionation method used in the invention is a technique for analyzing crystalline polymers, e.g., polyolefins, to determine the composition thereof or distribution of stereo regularity or noncrystallinity thereof, and is conducted by the following procedure.

First, a high-temperature solution of a sample resin is introduced into a column paced with a packing such as diatomaceous earth or glass beads and the column temperature is gradually lowered to thereby crystallize the components of the resin on the packing surface in order of their reducing melting point. Subsequently, the column temperature is gradually elevated to thereby elute the components in order of their increasing melting point. The components are thus fractionated. In this measurement in the invention, the rate of column temperature lowering was set at 2° C./hr and the rate of column temperature elevation was set at 4° C./hr. A detailed procedure for the temperature-rising elution fractionation method is described in Journal of Applied Polymer Science; Applied Polymer Symposium 45, 1-24 (1990).

In this fractionation method, a fraction of noncrystalline or extremely lowly crystalline components is obtained in a range of relatively low temperatures not higher than ordinary temperature, and a fraction of highly crystalline components comes to be obtained as the elution temperature increases. The amount of each fraction can be calculated from an elution curve obtained by plotting the elution temperature as abscissa and the integrated proportion by weight as ordinate.

### BRIEF DESCRIPTION OF THE DRAWINGS

FIG. 1 is a slant view showing one example (single wire) of wires to which the wire-protective tube of the invention can be applied.

FIG. 2 is a slant view showing another example (flat wires) of wires to which the wire-protective tube of the invention can be applied.

FIG. 3 is a slant view showing still another example (shielded wire) of wires to which the wire-protective tube of the invention can be applied.

FIG. 4 is a diagrammatic view illustrating the test apparatus used in a scrape abrasion test.

In Figs., sign 101 is a pressing member, sign 103 is a plunger, sign 104 is a clamp, sign 105 is a sample holder, sign 106 is a metal rod, sign 108 is a piano wire, and sign 111 is a tube.

### DETAILED DESCRIPTION OF THE INVENTION

The invention will be explained below in detail.

The wire-protective tube of the invention comprises as resin ingredients: a mixture of a microblend and a modified microblend obtained by modifying the microblend with an organic acid; and a polypropylene.

It is important that the microblend should be a resin which simultaneously satisfies the following requirements.

(1) In all components eluted and fractionated by the temperature-rising elution fractionation method using o-dibromobenzene solvent, the proportion of the component eluted in the temperature range of from −40° C. to 30° C. (hereinafter often referred to also as “low-temperature eluted component”) is from 10 to 90% by weight, preferably from 30 to 80% by weight.

(2) The microblend comprises from 1 to 70% by weight, preferably from 1 to 40% by weight, polypropylene and from 99 to 30% by weight, preferably from 99 to 60% by weight, propylene/ethylene random copolymer comprising from 15 to 50% by mole, preferably from 15 to 40% by mole, ethylene unit and from 85 to 50% by mole, preferably from 85 to 60% by mole, propylene unit.

A feature of the microblend resides in that the proportion of propylene unit in the propylene/ethylene random copolymer is large and, despite this, a sufficient content of the low-temperature eluted component is secured. Due to this feature, the wire-protective tube obtained is not only excellent in scrape resistance and rubbery properties but also superior in heat deformation properties to wire-protective tubes obtained from existing abrasion-resistant resin compositions comprising a flexible polyolefin containing ethylene unit as the main component. Furthermore, use of the microblend improves mechanical properties including tensile strength, and the wire-protective tube has improved strength brought about thereby.

When the content of the low-temperature eluted component in the microblend is lower than 10% by weight, this resin composition contains a large proportion of crystalline components and, hence, has reduced flexibility. In this case, a resin composition having a flexural modulus of 2,000 MPa or lower is difficult to obtain, leading to a decrease in the flexibility of the wire-protective tube.

When the content of the low-temperature eluted component in the microblend exceeds 90% by weight, the wire-protective tube has reduced resistance to instantaneous heating and the resin has enhanced tackiness. Because of these, problems are apt to arise, for example, that the wire-protective tube is difficult to cut.

When the microblend is analyzed by the temperature-rising elution fractionation method, it gives eluted-component fractions which have the following stepwise distribution. Due to this property, the microblend can impart various excellent properties, such as flexibility and heat resistance, to the wire-protective tube.

Specifically, the microblend is one which gives fractions in which the proportion of a component eluted in the temperature range of from −40° C. to less than 20° C. (hereinafter referred to as “component (a)”) is from 20 to 80% by weight, the proportion of a component eluted in the temperature range of from 20° C. to below 100° C. (hereinafter referred to as “component (b)”) is from 10 to 70% by weight, and the proportion of a component eluted at 100° C. or higher (hereinafter referred to as “component (c)”) is from 1 to 40% by weight according to the temperature-rising elution fractionation method using o-dichlorobenzene as a solvent (provided that the sum of component (a), component (b), and component (c) is 100% by weight).

Component (a) is a component contributing to the impartation of flexibility to the resin composition. When the proportion thereof is less than 20% by weight, the resin composition tends to have impaired flexibility, leading to a decrease in the flexibility of the wire-protective tube obtained. On the other hand, when the proportion of component (a) exceeds 80% by weight, the resin composition has reduced heat resistance and gives a wire-protective tube having reduced heat resistance. For obtaining a wire-protective tube having better flexibility and heat resistance, the proportion of component (a) is preferably from 30 to 70% by weight. In wire-protective tubes, flexibility is a property necessary for tube cutting and for wire binding and assembling.

Component (b) is a component which compatibilizes component (a) with component (c). As a result of this compatibility impartation, the resin composition obtained has a satisfactory balance between flexibility and heat resistance and this is reflected in properties of the wire-protective tube obtained. As in the case of component (a), proportions of component (b) smaller than 10% by weight result in a tendency for the resin composition to have impaired flexibility, while proportions thereof exceeding 70% by weight tend to result in insufficient heat resistance of the resin composition. For obtaining a wire-protective tube retaining a more satisfactory balance between flexibility and heat resistance, the proportion of component (b) is preferably from 15 to 50% by weight.

Component (c) is a component necessary for exhibiting the excellent heat resistance characteristics of polypropylene and for imparting excellent heat resistance to the wire-protective tube. Consequently, when the proportion of component (c) is less than 1% by weight, the resin composition tends to have insufficient heat resistance to give a wire-protective tube having reduced heat resistance. When the proportion of component (c) exceeds 40% by weight, the resin composition has impaired flexibility and gives a wire-protective tube having reduced flexibility. For obtaining better heat resistance, the proportion of component (c) is preferably in the range of from 5 to 30% by weight.

In the microblend to be used in the invention, the polypropylene corresponds to component (c) which is eluted according to the temperature-rising elution fractionation method (hereinafter sometimes referred to as “TREF”). As this polypropylene can be used, for example, a propylene homopolymer, a propylene/α-olefin random copolymer containing up to 10% by mole units derived from one or more α-olefins other than propylene, or a microblend comprising a polypropylene and a propylene/α-olefin random copolymer. These may be used alone or as a mixture of two or more thereof.

Examples of the α-olefins include ethylene, butene-1, 1-pentene, 1-hexene, 1-octene, 3-methyl-1-butene, and 4-methyl-1-pentene.

The propylene/ethylene random copolymer in the microblend in the invention roughly corresponds to component (a) and component (b) which are eluted by the TREF. For accomplishing the object of the invention, it is important in the propylene/ethylene random copolymer ingredient that the proportion of ethylene unit be from 15 to 50% by mole and the proportion of propylene unit be from 85 to 50% by mole. Preferably, the proportion of propylene unit is from 85 to 60% by mole and the proportion of ethylene unit is from 15 to 40% by mole.

When the proportion of propylene unit exceeds 85% by mole and the proportion of ethylene unit is less than 15% by mole, then the resin composition has impaired flexibility and gives a wire-protective tube having reduced flexibility. On the other hand, when the proportion of propylene unit is less than 50% by mole and the proportion of ethylene unit exceeds 50% by mole, then the resin composition has impaired heat resistance and gives a wire-protective tube having reduced heat resistance.

The microblend in the invention may contain units derived from one or more α-olefins other than propylene and ethylene, as long as these α-olefin units do not considerably alter the properties of the microblend. For example, the microblend may contain units of an α-olefin such as, e.g., 1-butene in an amount of up to 10% by mole.

The microblend described above for use in the invention can be produced, for example, by the method described in JP-A-5-320468. Part of the contents of JP-A-5-320468 has been hereby incorporated. It is understood that “microblend” in the invention is a material composed of a polypropylene and a propylene/ethylene random copolymer mixed therewith on a molecular level or nearly molecular level, like the materials produced by that method. Such a microblend can be commonly called a propylene/ethylene block copolymer.

The weight-average molecular weight of the microblend in the invention is not particularly limited. However, it is in the range of preferably from 7×10⁴ to 700×10⁴, more preferably from 20×10⁴ to 300×10⁴, most-preferably from 30×10⁴ to 200×10⁴, in terms of weight-average molecular weight determined by gel permeation chromatography (calculated from standard polystyrene).

The microblend is preferably used after having been regulated so as to have a melt flow rate (MFR) of about from 0.3 to 150 g/10 min. In the invention, the values of melt flow rate were obtained through measurements in accordance with JIS K7210.

It is important in the invention that the microblend should be used in combination with a modified microblend obtained by bonding organic acid groups to the microblend, for the purposes of improving the abrasion resistance reduced by the addition of the inorganic filler, without adversely influencing the effects of addition of the inorganic filler, and for thereby improving the scrape resistance of the wire-protective tube. In addition, the use of the modified microblend enables the ionically crosslinking filler, which will be described later, to be evenly dispersed in the resin composition and attains excellent flexing properties and excellent bending blush resistance.

The kind of the organic acid groups to be used is not particularly limited. Examples thereof generally include organic acid groups introduced by unsaturated organic acids or derivatives thereof such as acid anhydrides. Examples of such acids and derivatives include monobasic acids, dibasic acids, and acid anhydrides, such as acrylic acid, methacrylic acid, maleic acid, fumaric acid, itaconic acid, citraconic acid, maleic anhydride, citraconic anhydride, and itaconic anhydride. Examples thereof further include metal salts, imides, amides, and esters of those unsaturated organic acids.

For bonding organic acid groups to a microblend to obtain a modified microblend, known methods can be used without particular limitations. Examples thereof include: a method in which a microblend is brought into contact with an unsaturated organic acid or a derivative thereof, such as the acid anhydride, in an inert organic solvent; a method in which the reactants are irradiated with a radiation such as electron beams, X-rays, α-rays, or β-rays; and a method in which a reaction initiator represented by an organic peroxide is mixed with a microblend and an unsaturated organic acid or derivative thereof such as the acid anhydride and this mixture is treated by melt-kneaded. However, the method involving melt-kneading treatment is industrially most preferred. Still another practicable method is to copolymerize vinyl acetate, an acrylic ester, an unsaturated carboxylic acid, or the like during polymerization for microblend production.

Examples of the organic peroxide for use in one of those methods for obtaining a modified microblend include dicumyl peroxide, 2,5-dimethyl-2,5-di(t-butylperoxy)hexane, 2,5-dimethyl-2,5-(t-butylperoxy)hex-3-di-t-butyl peroxide, cumene hydroperoxide, t-butyl hydroperoxide, benzoyl peroxide, lauroyl peroxide, 1,3-bis (t-butylperoxyisobutyl)benzene, and α,α-bis(t-butylperoxydiisopropyl)benzene.

The modified microblend is preferably used after having being regulated so as to have a melt flow rate (MFR) of about from 0.3 to 250 g/10 min.

It is important that the amount of the organic acid groups in the modified microblend should be from 0.01 to 1 mmol based on 1 g of the whole mixture of the unmodified microblend and the modified microblend. When the concentration of combined organic acid groups in the whole microblend mixture is lower than 0.01 mmol/g, the resin composition has reduced abrasion resistance and gives a wire-protective tube having reduced scrape resistance. Even when the concentration of combined organic acid groups exceeds 1 mmol/g, not only such a high concentration is economically undesirable because a further improvement in effect which compensates for the increased acid group amount cannot be obtained, but also there are cases wherein the wire-protective tube obtained has reduced dielectric breakdown resistance. The preferred range of the concentration of combined organic acid groups in the whole microblend mixture is from 0.05 to 0.7 mmol/g, especially from 0.1 to 0.3 mmol/g.

A mixture of the microblend and the modified microblend in the invention can be produced by preparing a master batch having organic acid groups bonded in a large amount exceeding the range of from 0.01 to 1 mmol per g of the microblend and mixing this master batch with the microblend in such a proportion as to result in an organic acid group concentration within that range. The microblend/modified-microblend mixture preferably is a mixture of from 10 to 90% by weight the microblend and from 90 to 10% by weight the modified microblend.

A polypropylene may be separately added in such an amount that the resin composition to be obtained according to the invention satisfies the requirement concerning flexural modulus. This polypropylene incorporation is preferred because it improves the heat resistance of the resin composition and thereby enables the composition to give a wire-protective tube having improved heat resistance. The polypropylene is used in an amount of preferably up to 700 parts by weight, more preferably from 600 to 10 parts by weight, most preferably from 500 to 40 parts by weight, based on 100 parts by weight of the whole microblend mixture.

When the proportion of the polypropylene exceeds 700 parts by weight, the resin composition is apt to have impaired flexibility and give a wire-protective tube having reduced flexibility. The incorporation of the polypropylene in a proportion of 10 parts by weight or more is effective in further enhancing the heat resistance of the resin composition and further improving the heat resistance of the wire-protective tube.

As the polypropylene can be used a propylene homopolymer, a propylene/α-olefin copolymer containing up to 15% by mole units derived from one or more α-olefins other than propylene, and a microblend of a polypropylene and a propylene/α-olefin random copolymer. These may be used alone or in combination of two or more thereof. Examples of the α-olefins other than propylene include ethylene, butene-1,1-pentene, 1-hexene, 1-octene, 3-methyl-1-butene, and 4-methyl-1-pentene. The polypropylene preferably has a melt flow rate (MFR) of about from 0.3 to 150 g/10 min.

There are no limitations on the melt flow rate ratio between the modified microblend, microblend, and polypropylene, and on the crystallinity, stereoregularity, viscosity, content of components soluble (or insoluble) in a solvent such as heptane, hexane, or p-xylene, melting point, quantity of heat of fusion, and other various parameters of these materials, as long as these polymeric materials do not have impaired properties in the invention.

An ionically crosslinking filler is incorporated in the resin composition comprising ingredients (A) and (B) described above, which is to be used for constituting the wire-protective tube according the invention, for the purposes of imparting abrasion resistance, heat resistance, and rubbery properties and enabling the composition to give a wire-protective tube having a well balanced combination of scrape resistance and heat resistance with other properties. The ionically crosslinking filler hence acts, in melt-kneading, on the organic acid groups contained in the microblend to form an ionically crosslinked structure. Although this resin composition is a crosslinked material, it shows excellent suitability for recycling.

As the ionically crosslinking filler can be used, without any particular limitations, any of known fillers capable of forming ionic crosslinks with the organic acid groups. Examples thereof include magnesium oxysulfate, magnesium hydroxide, aluminum hydroxide, aluminumborate, calcium silicate, calcium carbonate, and hydrotalcite. Especially preferred of these are the hydroxides of polyvalent metals, such as magnesium hydroxide and aluminum hydroxide. Most preferred is magnesium hydroxide. The ionically crosslinking filler may be either a natural product or a synthetic product.

Examples of the shape of the ionically crosslinking filler include fibrous shapes and/or platy shapes. The fibrous fillers desirably are ones having an average fiber diameter of preferably from 0.1 to 2 μm, more preferably from 0.5 to 1.0 μm, and an aspect ratio of preferably from 3 to 1,000, more preferably from 15 to 80. The platy fillers desirably are ones which have an average particle diameter, as determined through a particle size distribution analysis by the laser diffraction/scattering method, of from 0.5 to 10 m, preferably from 1 to 6 μm, and an aspect ratio of from 3 to 200, preferably from 15 to 80. A fibrous ionically crosslinking filler and a platy ionically crosslinking filler may be used in combination in any desired proportion.

The surface of the ionically crosslinking filler can be treated with a known surface-treating agent. Examples of the surface-treating agent, which is used, for example, for improving dispersibility, include fatty acids such as oleic acid and stearic acid, metal salts of fatty acids, such as magnesium stearate, aluminum stearate, zinc stearate, sodium stearate, and potassium stearate, and coupling agents of various kinds such as silicones, silane compounds, phosphorous compounds, phosphoric esters, and phosphoric ester amines. Preferred of these are the fatty acids which are oleic acid and stearic acid, the fatty acid metal salts which are magnesium stearate and sodium stearate, and phosphoric esters because surface treatment with any of these improves dispersibility, flame retardancy, moisture resistance, water resistance, warm-water resistance, saline-solution resistance, etc. These surface-treating agents may be used in combination of two or more thereof.

The ionically crosslinking filler in the invention not only acts as a crosslinking agent on the resin composition, but also functions as a flame retardant when added in a large amount. It functions also as an acid scavenger which catches the free acid remaining after crosslinking. In particular, the metal hydroxides function as a flame retardant synergistically with the modified microblend to thereby exhibit exceedingly high flame retardancy. Consequently, the amount of the ionically crosslinking filler to be added is from 5 to 200 parts by weight, preferably from 10 to 180 parts by weight, based on 100 parts by weight of all resin ingredients consisting mainly of ingredients (A) and (B) described above.

When the amount of the ionically crosslinking filler incorporated is smaller than 5 parts by weight per 100 parts by weight of all resin ingredients, sufficient ionic crosslinking is not attained in the resin composition. When the amount thereof exceeds 200 parts by weight, the wire-protective tube obtained has an impaired appearance.

The presence of ionic crosslinks formed by the ionically crosslinking filler and polymerization can be ascertained by examining an infrared spectrum for gel parts present in the composition. Specifically, the ionic crosslinks give an absorption band ranging from 1,560 to 1,580 cm⁻¹ attributable to the linkages between carboxyl or acid anhydride groups and polyvalent metal ions; based on this, the crosslinking reaction can be ascertained to have occurred.

In the invention, the proportion of gel parts is in the range of preferably from 10 to 80% by weight, more preferably from 20 to 60% by weight. The proportion of gel parts can be regulated by controlling the concentration of organic acid groups in the modified microblend, proportion of the modified microblend to the microblend, amount of the ionically crosslinking filler to be incorporated, etc.

The presence of such special gel parts attributable to the modified microblend as described above produces an exceedingly marked effect on the heat resistance of the resin composition, as compared with polyolefin elastomers heretofore in use. This effect is reflected in the improvements in the scrape resistance and heat resistance of the wire-protective tube to be obtained and in the improvement of productivity as stated above.

Although the mechanism by which the presence of the gel parts produces those effects in the invention is unclear, the following is presumed. The gel parts comprise an ionically crosslinked modified microblend having a special crystallinity distribution. One feature of the properties thereof resides in that the gel parts swell moderately in solvents even when they have a relatively high average crosslink density. This brings about excellent dispersibility in the matrix resin.

In the reaction for bonding organic acid groups in the invention, crosslinked polymers generate in a slight amount. However, the gel in the resin composition of the invention may contain such crosslinked polymers in a small proportion together with the ionically crosslinked-polymers.

The term “gel parts in the resin composition” in the invention means the insoluble parts remaining undissolved after a sample resin composition in the form of strand-cut particles having a particle diameter of from 2.5 to 3.5 mm is subjected to 6-hour Soxhlet extraction with p-xylene. This term, gel parts, is for such a component in a polymer composition. Consequently, when a composition contains an insoluble ingredient other than crosslinked polymers, such as, e.g., an inorganic material, the gel content thereof is calculated as the proportion of the gel parts excluding such insoluble ingredient.

The flowability of the resin composition in a molten state in the invention is not particularly limited. The composition has a melt flow rate (hereinafter often abbreviated as MFR) of generally 100 g/10 min or lower, preferably 20 g/10 min or lower.

Various additives can be incorporated into the resin composition to be used in the invention, as long as the constitutional requirements for the invention are satisfied. For example, a polyolefin resin other than the microblend, modified microblend, and polypropylene described above can be incorporated. Examples of polyolefin resins which can be optionally incorporated include propylene/ethylene random copolymers, microblends of a polypropylene and a propylene/ethylene random copolymer, high-density polyethylene, medium-density polyethylene, low-density polyethylene, linear polyethylenes comprising a copolymer of ethylene and an α-olefin having 4 to 10 carbon atoms, ethylene/propylene copolymers (EPDM), ethylene/butene-1 copolymers, propylene/butene-1 copolymers, poly(1-butene), poly(1-pentene), poly(4-methylpentene-1), polybutadiene, and polyisoprene.

Examples of other resins which can be incorporated include ethylene/vinyl acetate copolymers, ethylene methacrylate, polychloroprene, halogenated polyethylene, halogenated polypropylene, fluororesins, acrylonitrile/butadiene rubbers, polystyrene, poly(butadiene terephthalate), polycarbonates, poly(vinyl chloride), fluororubbers, poly(ethylene terephthalate), polyamides, acrylonitrile/butadiene/styrene copolymers, petroleum hydrocarbon resins such as petroleum resins, hydrogenated petroleum resins, terpene resins, and hydrogenated terpene resins, and aromatic vinyl rubbers such as styrene/butylene/styrene block copolymers, styrene/isoprene/styrene block copolymers, styrene/ethylene/butylene/styrene block copolymers, styrene/propylene/butylene/styrene block copolymers, and products of hydrogenation of these copolymers. These resins may have, bonded thereto, organic acid groups of the kind described hereinabove.

It is desirable that those resins as additives be incorporated in an amount of preferably up to 100 parts by weight, more preferably up to 50 parts by weight, most preferably up to 40 parts by weight, per 100 parts by weight of the microblend mixture.

Besides the ionically crosslinking filler, other fillers may be incorporated according to need into the resin composition constituting the tube material in the invention. Examples of the optional fillers include known fibrous fillers such as potassium titanate fibers, glass fibers, carbon fibers, metal fibers, asbestos, wollastonite, gypsum fibers, mineral fibers, and organic fibers (e.g., polyamide fibers and polyester fibers), known platy fillers such as talc, mica, clay, glass flakes, graphite, aluminum flakes, kaolin clay, iron oxide, sericite, molybdenum disulfide, barium sulfate, and vermiculite, and known spherical fillers such as zeolite, diatomaceous earth, calcium carbonate, silica, silicates, and glass beads. These fillers may be used in combination of two or more thereof. The amount of these fillers to be incorporated is preferably from 0.1 to 80 parts by weight per 100 parts by weight of all resin ingredients.

Other additives can be further incorporated into the resin composition to be used in the invention as long as the effects of the invention are not impaired thereby. Examples thereof include heat stabilizers such as hindered amine compounds; weathering agents such as hindered amine compounds; ultraviolet absorbers such as benzophenone compounds, benzotriazole compounds, and benzoate compounds; antistatic agents such as nonionic, cationic, and anionic compounds; dispersants such as bisamide compounds and waxes; lubricants such as amide compounds, waxes, organometallic salts, and esters; decomposers such as oxides; metal deactivators such as melamine compounds, hydrazine compounds, and amines; flame retardants such as organic bromine compounds, phosphoric acid compounds, antimony trioxide, red phosphorus, silicon compounds, silica, melamine compounds, glass, and hydrous inorganic substances; organic pigments; inorganic pigments; clarifiers or nucleators such as sorbitol compounds, metal salts of aromatic phosphoric acids, and metal compounds of organic acids; antifogging agents; antiblocking agents; blowing agents; organic fillers; and inorganic antibacterials and organic antibacterials, such as metal ions. However, the additives which can be optionally added should not be construed as being limited to these. Such optional additives may be used in combination of two or more thereof.

Known phenolic antioxidants can be used according to need without particular limitations in the resin composition to be used in the invention. Examples thereof include 2,6-di-t-butyl-4-hydroxyphenol, 2,6-di-t-butyl-p-cresol, 2,6-diphenyl-4-octadecyloxyphenol, stearyl (3,5-di-t-butyl-4-hydroxyphenyl)propionate, distearyl (3,5-di-t-butyl-4-hydroxybenzyl)phosphonate, thiodiethylene glycol bis[(3,5-di-t-butyl-4-hydroxyphenyl)propionate], 4,4′-thiobis(6-t-butyl-m-cresol), 2-octylthio-4,6-di(3,5-di-t-butyl-4-hydroxyphenoxy)-s-triazine, 2,2′-methylenebis(4-methyl-6-t-butylphenol), 2,2′-methylenebis(4-ethyl-6-t-butylphenol), bis[3,3′-bis(4-hydroxy-3-t-butylphenyl)butyric acid]glycol esters, 4,4′-butylidenebis(6-t-butyl-m-cresol), 2,2′-ethylidenebis(4,6-di-t-butylphenol), 2,2′-ethylidenebis(4-t-butyl-6-t-butylphenol), 1,1,3-tris(2-methyl-4-hydroxy-5-t-butylphenyl)butane, bis[2-t-butyl-4-methyl-6-(2-hydroxy-3-t-butyl-5-methylbenzyl)phenyl]terephthalate, 1,3,5-tris(2,6-dimethyl-3-hydroxy-4-t-butylbenzyl) isocyanate, 1,3,5-tris(3,5-di-t-butyl-4-hydroxybenzyl) isocyanate, 1,3,5-tris(3,5-di-t-butyl-4-hydroxybenzyl)-2,4,6-trimethylbenzene, 1,3,5-tris[(3,5-di-t-butyl-4-hydroxyphenyl)propionyloxyethyl]isocyanate, tetrakis[methylene(3,5-di-t-butyl-4-hydroxyphenyl)propionate]methane, 2-t-butyl-4-methyl-6-(2-acryloyloxy-3-t-butyl-5-methylbenzyl)phenol, 3,9-bis(1,1-dimethyl-2-hydroxyethyl)-2,4,8,10-tetraoxaspiro[5.5]undecane bis[β-(3-t-butyl-4-hydroxy-5-methylphenyl)propionate], and triethylene glycol bis[β-(3-t-butyl-4-hydroxy-5-methylphenyl)propionate]. These phenolic antioxidants may be used alone or in combination of two or more thereof.

The amount of such a phenolic antioxidant to be added is generally from 0.001 to 1 part by weight, preferably from 0.01 to 0.8 parts by weight, based on 100 parts by weight of all resin ingredients. Addition amounts of the phenolic antioxidant smaller than 0.001 part by weight are undesirable because the resin deteriorates considerably and hence yellows. On the other hand, amounts thereof exceeding 1 part by weight are economically undesirable.

Known organophosphorus antioxidants can be used according to need without particular limitations in the resin composition to be used in the invention. Examples thereof include trisnonylphenyl phosphite, tris (2,4-di-t-butylphenyl) phosphite, di(tridecyl)pentaerythritol diphosphite, bis(2,4-di-t-butylphenyl)pentaerythritol diphosphite, bis(2,6-di-t-butyl-4-methylphenyl)pentaerythritol diphosphite, tetra(tridecyl)isopropylidenediphenol diphosphite, tetra(tridecyl)-4,4-n-butylidenebis(2-t-butyl-5-methylphenol)diphosphite, hexa(tridecyl)-1,1′,3-tris(3-t-butyl-4-hydroxy-5-methylphenyl)butane triphosphite, 2,2′-methylenebis(4,6-di-t-butylphenyl) octyl phosphite, 2,2′-methylenebis (4,6-di-t-butylphenyl) octadecyl phosphite, 2,2′-methylenebis (4,6-di-t-butylphenyl)fluorophosphite, and tetrakis(2,4-di-t-butylphenyl)biphenylene diphosphonate. These organophosphorus antioxidants may be used alone or in combination of two or more thereof.

It is desirable to incorporate such an organophosphorus antioxidant in an amount of from 0.001 to 1 part by weight, preferably from 0.01 to 0.8 parts by weight, based on 100 parts by weight of all resin ingredients. Addition amounts thereof smaller than 0.001 part by weight are undesirable because the resin deteriorates considerably and hence yellows. On the other hand, amounts thereof exceeding 1 part by weight are economically undesirable.

Known thioether antioxidants can be used according to need without particular limitations in the resin composition to be used in the invention. Examples thereof include dialkyl thiodipropionates such as the dilauryl, dimyristyl, and distearyl esters of thiodipropionic acid and β-alkylmercaptopropionic acid esters of polyols, such as pentaerythritol tetra(β-dodecylmercaptopropionate). These thioether antioxidants may be used alone or in combination of two or more thereof.

It is desirable to incorporate such a thioether antioxidant in an amount of from 0.001 to 1 part by weight, preferably from 0.01 to 0.8 parts by weight, based on 100 parts by weight of all resin ingredients. Addition amounts thereof smaller than 0.001 part by weight are undesirable because the resin deteriorates considerably and hence yellows. On the other hand, amounts thereof exceeding 1 part by weight are economically undesirable.

Besides being used alone, the phenolic antioxidants, organophosphorus antioxidants, and thioether antioxidants enumerated above may be used in combination of two or more thereof. When a combination of two or more of these is used, the total amount of these to be added is generally from 0.001 to 2 parts by weight, preferably from 0.01 to 1 part by weight, based on 100 parts by weight of all resin ingredients.

For blending the ingredients described above in the invention, methods in ordinary use for resin mixing can be employed without particular limitations. For example, a preferred method comprises mixing the resins in a powder or pellet form with other resins, additives, fillers, etc. by means of a tumbler, Henschel mixer, Banbury mixer, ribbon feeder, supermixer, or the like, subsequently melt-kneading the mixture with a single- or multi-screw extruder (preferably a vented melt-kneading apparatus), roll mill, kneader, Banbury mixer, or the like at a kneading temperature of from 150 to 350° C., preferably from 190 to 280° C., and then pelletizing the mixture. The sequence of adding those ingredients is not particularly limited, and the ingredients may be mixed in an order different from the above one. It is also possible to prepare a master batch containing optional additives and fillers in a high concentration and mix this master batch with the resins.

The wire-protective tube of the invention is formed from the resin composition described above. Because of this, the resin shows excellent extrudability in tube production and satisfactory productivity is obtained. In order for a resin to be used for producing a wire-protective tube therefrom by high-speed extrusion molding without adversely influencing the tube appearance, the resin is required to be free from the melt fracture phenomenon and have a small swell ratio. The poor appearance of PE-based wire-protective tubes produced at a high speed is attributable to the melt fracture phenomenon. In the production of PVC-based wire-protective tubes also, the melt fracture phenomenon occurs in higher-speed molding and the production speed is hence limited. In contrast, when the resin composition according to the invention is used at a speed higher than the limit production speed for the PVC-based wire-protective tubes, a wire-protective tube free from the appearance failures attributable to the melt fracture phenomenon can be stably produced. Since an improvement in productivity is obtained, use of the resin composition according to the invention is superior also from the standpoint of profitability. Furthermore, the wire-protective tube of the invention has excellent properties from the standpoint of environmental preservation, such as suitability for recycling and the property of not generating a harmful gas during combustion, in addition to the properties described above due to the resin composition constituting the tube.

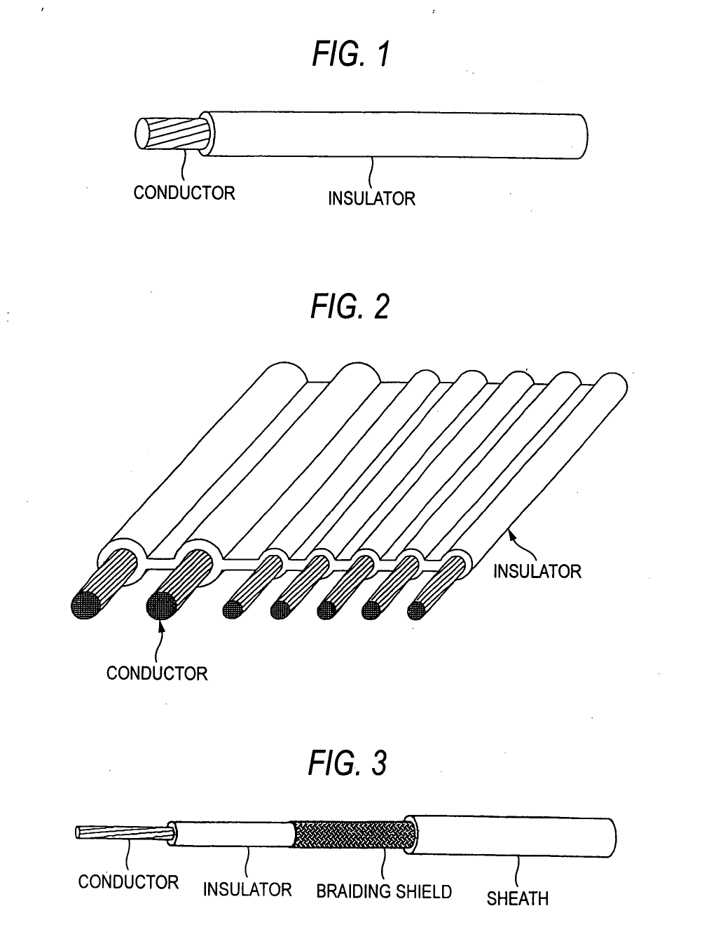

The wire-protective tube of the invention can be used without particular limitations for the protection of known electric wires including PVC-coated wires and wires coated with a material consisting substantially of a resin composition containing a halogenated flame retardant and/or halogen-free flame retardant. With respect to the constitutions of such insulated wires, known constitutions such as, e.g., the single wire shown in FIG. 1, flatly arranged wires shown in FIG. 2, and shielded wire shown in FIG. 3 can be employed without particular limitations. The wire-protective tube of the invention can be used, without particular limitations, for the binding/protection of all kinds of wires, including automotive harness wires, wires in domestic electrical appliances, power supply wires, wires in instruments, information channel wires, optical fiber cables, and wires in electric cars, ships, aircraft, and the like. For application to those wire constitutions, the tube generally has a thickness of about from 0.1 to 5 mm.

### EXAMPLES

The invention will be explained below in more detail by reference to Examples and Comparative Examples, but the invention should not be construed as being limited to these Examples. In the Examples and Comparative Examples, various measurements and evaluations were made by the following methods. The wire-protective tubes subjected to the evaluations were obtained by extrusion-molding each resin composition which will be described later with a 50-mmφ extruder (φ50, L/D=2.3, FF screw) at a die temperature of 200° C. and a haul-off speed of 40 m/min so as to result in a wall thickness of 0.3 mm and an inner diameter of 10 mm.

(1) Evaluation of Wire-Protective Tube

(a) Abrasion Resistance (Scrape Abrasion Test)

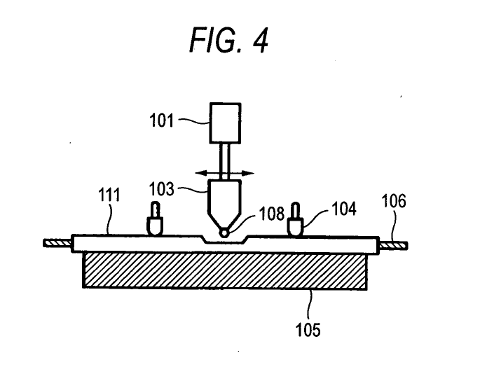

As shown in FIG. 4, a metal rod 106 having a diameter of 5 mm was sheathed with a tube 111 having a length of about 40 mm, and this sheathed rod was placed on a sample holder 105 and fixed with clamps 104. A piano wire 108 having a diameter of 0.45 mm fitted to the tip of a plunger 103 was reciprocated on the tube 111 over a distance of 15 mm while applying a total load of 10 N with a pressing member 101. The number of reciprocations required for the plunger 103 to penetrate the tube 111 and come into contact with the metal rod 106 was counted.

◯: The number of reciprocations was 250 or larger.

X: The number of reciprocations was less than 250.

(b) Tube Flexibility (Suitability of Tube for Winding)

A tube was wound on a drum having a radius of 0.6 m under no tension to examine the state of the tube roll.

◯: Satisfactory.

X: Bending occurred.

(c) Oil Resistance

A tube was split open, and a test piece of the No. 3 dumbbell shape provided for in JIS C 6251 was punched out thereof. This test piece was immersed for 20 hours in a test oil [engine oil/kerosene=50/50 (by weight)] heated at 50° C. and was then examined for load at break and elongation at break.

◯: Residual elongation was 70% or higher.

X: Residual elongation was less than 70%.

(d) Heat Resistance (Resistance to Instantaneous Heating)

A tube was held for 30 minutes in an oven having a temperature of 170° C., subsequently taken out, and then examined for the occurrence of fusion, cracking, or fracture.

◯: No change.

X: Fusion, cracking, or fracture occurred.

(2) Properties of Resin Composition, etc.

(a) Weight-Average Molecular Weight of Propylene/Ethylene Block Copolymer

The apparatus and measuring conditions used were: GPC-150C, manufactured by Waters Inc.; temperature, 135° C.; solvent, o-dichlorobenzene; column, TSK GMH 6-HT, manufactured by Tosoh Corp.; and gel size, 10-15 μm. A calibration curve for converting a polypropylene elution curve to a molecular-weight distribution curve was determined by the following method. Monodisperse polystyrenes respectively having molecular weights of 950, 2,900, 1×10⁴, 5×10⁴, 49.8×10⁴, 270×10⁴, 675×10⁴, and 2,060×10⁴ were used as standard samples to obtain a calibration curve for polystyrenes. This calibration curve was converted to a calibration curve for polypropylenes by the method described in Geru Pâmiêshon Kuromatogurafî (published by Maruzen Co., Ltd. on May 20, 1976), pp. 64-66. The constants used for the conversion are values given in the Table 5 attached in the document.

(b) Measurement of Amount of Organic Acid Groups in Modified Propylene/Ethylene Block Copolymer Resin

A calibration curve was drawn in order to determine the amount of an organic acid grafted to a modified propylene/ethylene block copolymer. Styrene and a given organic acid were added to benzene. Azobisisobutyronitrile was added thereto to obtain a styrene/organic acid copolymer. This copolymer was mixed with a propylene homopolymer to obtain mixtures, which were formed into sheets. The sheets were examined with an infrared spectrophotometer. A calibration curve was determined from the absorbances for the organic acid and from the sheet thickness. The modified propylene/ethylene block copolymer was completely dissolved in p-xylene with heating and then reprecipitated from a large amount of methanol. The precipitate was dried, formed into a sheet, and then examined with an infrared spectrophotometer for absorbance for the organic acid. The amount of the organic acid groups contained in the modified propylene/ethylene block copolymer was determined with the calibration curve.

(c) Temperature-Rising Elution Fractionation Method

Measurement was made with SSC-7300, manufactured by Senshu Kagaku K.K., under the following conditions.

| | |
|---|---|
| Solvent: | o-dichlorobenzene or o-dibromobenzene |
| Flow rate: | 2.5 mL/min |
| Heating rate | 4.0° C./hr |
| Sample concentration: | 0.7 wt % |
| Sample injection amount: | 100 mL |
| Detector: | infrared detector; wavelength, 3.14 μm |
| Column: | φ30 mm × 300 mm |
| Packing: | Chromosorb P; 30-60 mesh |
| Column cooling rate: | 2.0° C./hr |

(d) Flexural Modulus

Determined in accordance with JIS K7203.

(e) Proportion of Gel Parts

In a stainless-steel gauze bag was placed 5 g of a strand-cut sample having a particle diameter of from 2.5 to 3.5 mm. This sample was subjected to 6-hour Soxhlet extraction in boiling p-xylene. After the extraction, the residual sample was dried in a vacuum dryer at 70° C. for 18 hours and the amount of the extraction residue (gel content) was then measured. The term gel parts is for such insoluble component in a polymer composition. In the case of a composition containing an insoluble ingredient, e.g., an inorganic material, other than crosslinked polymers, the proportion of gel parts therein was calculated after exclusion of the insoluble ingredient through burning, etc.

[Preparation of Sample 1]

(Prepolymerization)

The atmosphere in an autoclave reactor made of glass having a capacity of 1 L and equipped with a stirrer was sufficiently replaced with nitrogen gas. Thereafter, 400 mL of hexane was charged into the autoclave. Thereto were added 4.2 mmol of dicyclopentyldimethoxysilane, 21.5 mmol of ethyl iodide, 21.5 mmol of triethylaluminum, and 21.5 mmol of titanium trichloride (manufactured by Marubeni Solvay Kagaku) while keeping the internal temperature of the reactor at 20° C. Thereafter, propylene was continuously introduced into the reactor over 30 minutes in an amount of 3 g per g of the titanium trichloride. During this period, the temperature was kept at 20° C. After the propylene feeding was stopped, the atmosphere in the reactor was sufficiently replaced with nitrogen gas. Subsequently, the resultant titanium-containing polypropylene was washed with purified hexane four times. As a result of analysis, propylene was found to have been polymerized in an amount of 2.7 g per g of the titanium trichloride.

(Main Polymerization)

Into a 2-m³ autoclave the atmosphere in which had been replaced with N₂ were introduced 1 m³ of liquid propylene, 2.4 mol of triethylaluminum, and 1.2 mol of dicyclopentylmethoxysilane. Hydrogen was also introduced in such an amount that the hydrogen concentration in the gas phase became 1.0 mol %. The internal temperature of the autoclave was elevated to 55° C. Subsequently, ethylene was fed in such an amount that the ethylene concentration in the gas phase was kept at 1.5 mol % and the titanium-containing polypropylene obtained by the prepolymerization was added thereto in an amount of 0.3 mol in terms of titanium trichloride amount. Thus, propylene/ethylene copolymerization was conducted at 55° C. for 20 minutes (step 1). Subsequently, ethylene was further fed in such an amount that the ethylene gas concentration in the gas phase was increased to and kept at 10 mol %. Thus, polymerization was conducted for 120 minutes (step 2). Thereafter, the monomers remaining unreacted were removed by purging to obtain a microblend. The microblend thus obtained was dried at 70° C. for 1 hour. This microblend was examined for various properties, and the results obtained are shown in Table 1 in the row “Sample 7”.

(Molecular Weight Regulation)

To 100 parts by weight of the microblend were added 0.2 parts by weight of an antioxidant and 0.05 parts by weight of 1,3-bis(t-butylperoxyisopropyl)benzene as an organic peroxide. These ingredients were mixed together and then extrusion-molded at 230° C. to obtain pellets having a reduced molecular weight. The microblend thus obtained was examined for various properties, and the results obtained are shown in Table 1 in the row “Sample 1”.

[Preparation of Sample 2]

A microblend was produced in the same manner as for the preparation of sample 1, except that the ethylene feed amount and hydrogen feed amount were changed. From this microblend was produced a microblend having a regulated molecular weight (sample 2) in the same manner as for the preparation of sample 1. The microblend thus obtained was examined for various properties, and the results obtained are shown in Table 1 in the row “Sample 2”.

[Preparation of Sample 8]

The microblend to be used for preparing sample 2 therefrom was examined, before the decomposition, for various properties. The results obtained are shown in Table 1 in the row “Sample 8”.

[Preparation of Sample 3]

A propylene/ethylene random copolymer was obtained in the same manner as for the preparation of sample 1, except that the ethylene gas concentration in step 1 was regulated to 1.0 mol % to conduct polymerization at 55° C. for 150 minutes and that step 2 was omitted. This copolymer was examined for various properties, and the results obtained are shown in Table 1 in the row “Sample 3”.

[Preparation of Sample 4]

A microblend was produced using a metallocene catalyst and a microblend having a regulated molecular weight (sample 4) was obtained in the same manner as for the preparation of sample 7. The microblend obtained was examined for various properties and the results obtained are shown in Table 1 in the row “Sample 4”.

[Preparation of Sample 5]

A TPO comprising a commercial ethylene/propylene copolymer was examined for various properties. The results obtained are shown in Table 1 in the row “Sample 5”.

[Preparation of Sample 6]

A commercial polypropylene (RB110, manufactured by Tokuyama Corp.) was examined for various properties. The results obtained are shown in Table 1 in the row “Sample 6”.

TABLE 1
Kinds of Polymers

| | | | | | TREF*² | | | | |
|---|---|---|---|---|---|---|---|---|---|
| | | | | TREF*¹ | Proportion of eluted | | | | |
| | | Propylene/ethylene | | Proportion | Component | | | Weight- | |
| | | random copolymer | | of | | from | | average | |
| | | component | | component | | 20° C. | | molecular | |
| | | | Ethylene | eluted at | Less | to less | 100° C. | weight, | |
| | | Proportion | content | −40 to 30° C. | than | than | or | Mw | MFR |
| Polymer | Kind | (wt %) | (mol %) | (wt %) | 20° C. | 100° C. | higher | (×10⁴) | (g/10 min) |
| Sample 1 | microblend | 91 | 36 | 70 | 68 | 23 | 9 | 34 | 1.5 |
| Sample 2 | microblend | 86 | 26 | 55 | 51 | 35 | 14 | 35 | 1.5 |
| Sample 3 | random | 95 | 6 | 8 | 6 | 10 | 84 | 29 | 1.4 |
| | copolymer | | | | | | | | |
| Sample 4 | microblend | 91 | 89 | 21 | 17 | 74 | 9 | 31 | 2.1 |
| Sample 5 | microblend | 99.5 | 45 | 96 | 90 | 9.5 | 0.5 | 57 | 0.5 |
| Sample 6 | propylene | 0 | 0 | 3 | 2 | 3 | 95 | 54 | 0.5 |
| | homopolymer | | | | | | | | |
| Sample 7 | polymer before | 91 | 36 | 70 | 67 | 24 | 9 | 95 | 0.1 |
| | decomposition | | | | | | | | |
| | for | | | | | | | | |
| | sample 1 | | | | | | | | |
| Sample 8 | polymer before | 86 | 26 | 56 | 50 | 36 | 14 | 94 | 0.1 |
| | decomposition | | | | | | | | |
| | for | | | | | | | | |
| | sample 2 | | | | | | | | |

*¹with o-dibromobenzene
*²with o-dichlorobenzene

The abbreviations for the fillers used in the Examples and Comparative Examples are shown in Table 2.

TABLE 2
Kinds of Fillers

| Abbreviation | Kind of filler |
|---|---|
| A | synthetic magnesium hydroxide (platy) |
| B | talc (platy) |

In Table 1, the proportion of propylene/ethylene copolymer component in each propylene/ethylene block copolymer means the total proportion of components (a) and (b) eluted, respectively, in the range of temperatures less than 20° C. and in the temperature range of from 20° C. to less than 100° C. according to the temperature-rising elution fractionation method with o-dichlorobenzene solvent. Furthermore, the ethylene content in each copolymer means the ethylene content in the propylene/ethylene copolymer.

### Example 1

To 100 parts by weight of a microblend (sample 7) were added 0.05 parts by weight of tetrakis[methylene(3,5-di-t-butyl-4-hydroxyphenyl)propionate]methane as an antioxidant, 0.9 parts by weight of 1,3-bis (t-butylperoxyisobutyl)benzene, and 4.5 parts by weight of maleic anhydride. These ingredients were sufficiently mixed together by means of a Henschel mixer. The resultant mixture was melt-kneaded with a 50-mmφ single-screw extruder to obtain a modified microblend through strand cutting. The modified microblend obtained had an MFR of 50 g/10 min and an organic acid group concentration of 0.29 mmol/g.

Subsequently, a microblend, the modified microblend, a polypropylene, and filler A (magnesium hydroxide (crosslinking agent)), shown in Table 2, were mixed in the respective amounts shown in Table 3-together with 0.05 parts by weight of tetrakis[methylene(3,5-di-t-butyl-4-hydroxyphenyl) propionate]methane as an antioxidant. This mixture was sufficiently stirred and homogenized with a Henschel mixer. Thereafter, the mixture was melt-kneaded with a vented 45-mmφ twin-screw extruder to obtain a resin composition through strand cutting. The resin composition thus obtained was used to mold a wire-protective tube by the method described above. Found values of various properties are shown in Table 3 and the evaluation results are shown in Table 5.

### Examples 2 to 4

Resin compositions were obtained in the same manner as in Example 1, except that the amounts of the microblend, modified microblend, and magnesium hydroxide were changed as shown in Table 3. The resin compositions obtained were used to mold wire-protective tubes. Found values of various properties are shown in Table 3 and the evaluation results are shown in Table 5.

### Example 5

To 100 parts by weight of a microblend (sample 8) were added 0.05 parts by weight of tetrakis[methylene(3,5-di-t-butyl-4-hydroxyphenyl) propionate]methane as an antioxidant, 0.9 parts by weight of 1,3-bis (t-butylperoxyisobutyl)benzene, and 4.5 parts by weight of maleic anhydride. These ingredients were sufficiently mixed together by means of a Henschel mixer. The resultant mixture was melt-kneaded with a 50-mmφ single-screw extruder to obtain a modified microblend through strand cutting. The modified microblend obtained had an MFR of 107 g/10 min and an organic acid group concentration of 0.20 mmol/g.

Subsequently, a microblend (sample 1), the modified microblend, and magnesium hydroxide (crosslinking agent) were added in the respective amounts shown in Table 3 to 100 parts by weight of a polypropylene together with 0.05 parts by weight of tetrakis[methylene(3,5-di-t-butyl-4-hydroxyphenyl) propionate]methane as an antioxidant. This mixture was sufficiently stirred and homogenized with a Henschel mixer. Thereafter, the mixture was melt-kneaded with a vented 45-mmφ twin-screw extruder to obtain a resin composition through strand cutting. The resin composition thus obtained was used to mold a wire-protective tube by the method described above. Found values of various properties are shown in Table 3 and the evaluation results are shown in Table 5.

### Comparative Examples 1 to 7

Wire-protective tubes were obtained in the same manner as in Example 1, except that a modified microblend was blended with a random copolymer or microblend, a polypropylene, and magnesium hydroxide in the respective amounts shown in Table 4. Found values of various properties are shown in Table 4 and the evaluation results are shown in Table 5.

TABLE 3

| | Resin Composition | | | | | | | | | | | | | |
|---|---|---|---|---|---|---|---|---|---|---|---|---|---|---|
| | Mixture | | | | | | | Filler | | | | | | |
| | | | | | Concentration | | | | | Average | | | | |
| | Microblend | | Modified | | of | Polypropylene | | | | fiber | | | | |
| | (unmodified) | | microblend | | organic | | Amount*² | | Amount*³ | or | | | | |
| | | Pro- | | Pro- | acid | | (parts | | (parts | particle | As- | | Flexural | Gel |
| | | portion | | portion | groups | | by | | by | diameter | pect | MFR | modulus | amount |
| | Kind | (wt %) | Kind*¹ | (wt %) | (mmol/g) | Kind | weight) | Kind | weight) | (μm) | ratio | (g/10 min) | (MPa) | (wt %) |
| Ex. 1 | sam- | 75 | sam- | 25 | 0.07 | sam- | 37.5 | A | 82 | 1.2 | 5 | ≦0.01 | 310 | 30 |
| | ple 1 | | ple 7 | | | ple 6 | | | | | | | | |
| Ex. 2 | sam- | 75 | sam- | 25 | 0.07 | Sam- | 37.5 | A | 82 | 1.2 | 5 | ≦0.01 | 400 | 29 |
| | ple 2 | | ple 7 | | | ple 6 | | | | | | | | |
| Ex. 3 | sam- | 85 | sam- | 15 | 0.04 | sam- | 11 | A | 160 | 1.2 | 5 | ≦0.01 | 620 | 23 |
| | ple 1 | | ple 7 | | | ple 6 | | | | | | | | |
| Ex. 4 | sam- | 30 | sam- | 70 | 0.20 | sam- | 500 | A | 25 | 1.2 | 5 | ≦0.01 | 1600 | 21 |
| | ple 1 | | ple 7 | | | ple 6 | | | | | | | | |
| Ex. 5 | sam- | 75 | sam- | 25 | 0.05 | sam- | 37.5 | A | 82 | 1.2 | 5 | ≦0.01 | 330 | 28 |
| | ple 1 | | ple 8 | | | ple 6 | | | | | | | | |

*¹Microblend before modification.
*²Per 100 parts by weight of the mixture.
*³Per 100 parts by weight of the sum of microblend resin and polypropylene.

TABLE 4

| | Resin Composition | | | | | | | | | | | | | |
|---|---|---|---|---|---|---|---|---|---|---|---|---|---|---|
| | Mixture | | | | | | | | | | | | | |
| | | | | | Concentra- | | | Filler | | | | | | |
| | Microblend | | Modified | | tion of | Polypropylene | | | | Average | | | | |
| | (unmodified) | | microblend | | organic | | Amount*² | | Amount*³ | fiber | | | | |
| | | Pro- | | Pro- | acid | | (parts | | (parts | or particle | As- | | Flexural | Gel |
| | | portion | | portion | groups | | by | | by | diameter | pect | MFR | modulus | amount |
| | Kind | (wt %) | Kind*¹ | (wt %) | (mmol/g) | Kind | weight) | Kind | weight) | (μm) | ratio | (g/10 min) | (Mpa) | (wt %) |
| Comp. | sam- | 75 | sam- | 25 | 0.07 | sam- | 37.5 | A | 82 | 1.2 | 5 | ≦0.01 | 1900 | 14 |
| Ex. 1 | ple 3 | | ple 7 | | | ple 6 | | | | | | | | |
| Comp. | sam- | 75 | sam- | 25 | 0.07 | sam- | 37.5 | A | 82 | 1.2 | 5 | ≦0.01 | 290 | 13 |
| Ex. 2 | ple 4 | | ple 7 | | | ple 6 | | | | | | | | |
| Comp. | sam- | 75 | sam- | 25 | 0.07 | sam- | 37.5 | A | 82 | 1.2 | 5 | ≦0.01 | 280 | 13 |
| Ex. 3 | ple 5 | | ple 7 | | | ple 6 | | | | | | | | |
| Comp. | sam- | 95 | sam- | 5 | 0.01 | sam- | 37.5 | A | 82 | 1.2 | 5 | ≦0.01 | 290 | 2 |
| Ex. 4 | ple 1 | | ple 7 | | | ple 6 | | | | | | | | |
| Comp. | sam- | 75 | sam- | 25 | 0.07 | sam- | 800 | A | 82 | 1.2 | 5 | ≦0.01 | 2700 | 6 |
| Ex. 5 | ple 1 | | ple 7 | | | ple 6 | | | | | | | | |
| Comp. | sam- | 75 | sam- | 25 | 0.07 | sam- | 37.5 | A | 230 | 1.2 | 5 | ≦0.01 | 2100 | 10 |
| Ex. 6 | ple 1 | | ple 7 | | | ple 6 | | | | | | | | |
| Comp. | sam- | 75 | sam- | 25 | 0.07 | sam- | 37.5 | B | 82 | 4.0 | 11 | ≦0.01 | 320 | 0.1 |
| Ex. 7 | ple 1 | | ple 7 | | | ple 6 | | | | | | | | |

*¹Microblend before modification.
*²Per 100 parts by weight of the mixture.
*³Per 100 parts by weight of the sum of microblend resin and polypropylene.

TABLE 5

| | Properties Evaluated | | | |
|---|---|---|---|---|
| | | | | Heat resistance |
| | Scrape | Tube | Oil | (heat deformation |
| | resistance | flexibility | resistance | property) |
| Example 1 | ◯ | ◯ | ◯ | ◯ |
| Example 2 | ◯ | ◯ | ◯ | ◯ |
| Example 3 | ◯ | ◯ | ◯ | ◯ |
| Example 4 | ◯ | ◯ | ◯ | ◯ |
| Example 5 | ◯ | ◯ | ◯ | ◯ |
| Comparative | X | X | X | X |
| Example 1 | | | | |
| Comparative | X | ◯ | X | X |
| Example 2 | | | | |
| Comparative | X | ◯ | X | X |
| Example 3 | | | | |
| Comparative | X | X | X | X |
| Example 4 | | | | |
| Comparative | X | X | X | X |
| Example 5 | | | | |
| Comparative | X | X | X | ◯ |
| Example 6 | | | | |
| Comparative | X | X | X | X |
| Example 7 | | | | |

As is apparent from Table 5, the wire-protective tubes obtained in the Examples according to the invention each gave satisfactory results with respect to all the properties evaluated.

As can be understood from the explanation given above, the wire-protective tube of the invention not only has the satisfactory insulating properties, water resistance, and oil resistance possessed by flexible polyolefins, but also is improved in flexing property, scrape resistance, and heat resistance and has satisfactory productivity in production by extrusion molding, because a resin composition which is a specific flexible-polyolefin composition is used as the material for the tube.

1. A wire-protective tube comprising a resin composition comprising:
(A) a mixture comprising a microblend and a modified miocroblend,
wherein the microblend comprises from 1 to 70% by weight of polypropylene and from 99 to 30% by weight of propylene/ethylene random copolymer comprising from 15 to 50% by mole of ethylene unit and from 85 to 50% by mole of propylene unit,
wherein (a) a component eluted in the temperature range of from −40° C. to less than 20° C. is included in an amount of from 20 to 80% by weight, (b) a component eluted in the temperature range of from 20° C. to less than 100° C. is included in an amount of from 10 to 70% by weight, and (c) a component eluted at 100° C. or higher is included in an amount of from 1 to 40% by weight according to the temperature-rising elution fractionation method using o-dichlorobenzene as a solvent,
wherein the content of a component eluted in the temperature range of from −40° C. to 30° C. is from 10 to 90% by weight based on all the components according to the temperature-rising elution fractionation method using o-dibromobenzene as a solvent, and
wherein the modified microblend comprises the microblend and organic acid groups bonded thereto, wherein the amount of the organic acid groups is from 0.01 to 1 mmol based on 1 g of the sum of the microblend and the modified microblend,
(B) from 0 to 700 parts by weight of a polypropylene based on 100 parts by weight of the mixture, and
(C) from 5 to 200 parts by weight of an ionically crosslinking filler based on 100 parts by weight of the sum of ingredients (A) and (B),
wherein the resin-composition has a flexural modulus of 2,000 MPa or lower.

2. The wire-protective tube according to claim 1, wherein the mixture comprises the microblend in an amount of from 10 to 90% by weight and the modified microblend in an amount of from 90 to 10% by weight.

3. The wire-protective tube according to claim 1, wherein the resin composition contains a gel in an amount of from 10 to 80% by weight.

4. The wire-protective tube according to claim 1, wherein the ionically crosslinking filler is magnesium hydroxide.
